(19) United States
(12) Patent Application Publication
(10) Pub. No.: US 2016/0106625 A1
(43) Pub. Date: Apr. 21, 2016

(54) MEDICATION DOSAGE SYSTEM

(71) Applicant: Pain Management Company, LLC, Horsham, PA (US)

(72) Inventors: Brian Dunleavy, Horsham, PA (US); Gregory Guinette, Horsham, PA (US); John Talamo, Horsham, PA (US); Lynne Maleeff, Horsham, PA (US)

(21) Appl. No.: 14/886,019

(22) Filed: Oct. 17, 2015

Related U.S. Application Data
(60) Provisional application No. 62/065,256, filed on Oct. 17, 2014.

(51) Int. Cl. A61J 7/00; B65D 83/08; B65D 25/04

(52) U.S. Cl. CPC A61J 7/0084; B65D 25/04; B65D 83/0805; A61J 2205/40; A61J 2205/30; A61J 2205/10

(57) ABSTRACT

A medication management system according to some embodiment may include a box with multiple sections and medication packaging strips. At least two of the medication packaging strips may include medication dose envelopes serially connected together. At least two of the multiple sections in the box may include a dispensing opening allowing the medication packaging strips to be dispensed serially through the dispensing openings. The medication management system may include a tactile marker between medication dose envelopes. In some embodiments the tactile marker may include a notch in the medication packaging strip. The tactile marker may include a raised feature in the medication packaging strip. The tactile marker may be on an empty medication dose envelope positioned between and connecting two filled medication dose envelopes.

### CLAIM OF PRIORITY UNDER 35 U.S.C. §§119(E)

This application claims priority to U.S. provisional application Ser. No. 62/065,256 titled “MEDICATION DOSAGE SYSTEM” and filed Oct. 17, 2014; which application is incorporated herein in its entirety.

### BACKGROUND

1. Technical Field

This disclosure relates to home healthcare, prescription fulfillment, and medication management and packaging.

2. Background Art

Sight-impaired people taking multiple medications per day have a difficult time keeping track of what they have taken and when (non-sight impaired people also have this challenge if they are memory-impaired or taking more than 6 medications a day with different dosages). Home health providers are particularly challenged by this problem because they are penalized if patients in their care are readmitted to the hospital, and statistics show that failure to take medications as directed is a significant cause of hospital readmissions nationwide.

Blind people currently are using readers and homegrown systems (like putting raised stickers on certain bottles) to try to keep track of which bottle is which, but those solutions do not help the patient know which medication they have taken or when, nor does it enable caregivers to know which medications have been taken and when. This problem is especially challenging for blind patients but also for patients with dementia.

### BRIEF SUMMARY

A medication management system according to some embodiment may include a box with multiple sections and medication packaging strips. At least two of the medication packaging strips may include medication dose envelopes serially connected together. At least two of the multiple sections in the box may include a dispensing opening allowing the medication packaging strips to be dispensed serially through the dispensing openings.

The medication management system may include a tactile marker between medication dose envelopes. In some embodiments the tactile marker may include a notch in the medication packaging strips. The tactile marker may include a raised feature in the medication packaging strips. The tactile marker may be on an empty medication dose envelope positioned between and connecting two filled medication dose envelopes.

In some embodiments the medication dose envelopes include a reminder envelope for non-pill medications. The reminder envelope may include a scannable code.

The box may include a top and a bottom, and the dispensing opening may be positioned near the top. The box may include a cut to create a flap below the dispensing opening, where the flap may be configured to hold a portion of the medication packaging strips. The box may include printed lettering on an exterior of the box corresponding to the multiple sections. braille markings may be placed over the printed lettering on the box. In some embodiments the braille markings may be formed on a substantially transparent sticker. The substantially transparent sticker may be placed over the printed lettering. The box may have an exterior and may include a scannable code. The box may include a tactile feature that can be recognized by touch adjacent to the scannable code. The tactile feature may include a raised box shape which surrounds the scannable code.

In some embodiments the two sections include markings that correspond with a time of day when medications should be taken. At least two of the medication packaging strips may have medication dosages in the medication dose envelopes marked as designated for the time of day corresponding with the section.

In some embodiments the medication packaging strips may include a section between the medication dose envelopes that may include printed contact information for medical professionals related to a patient for whom the medications are dispensed. The section between the medication dose envelopes may include an unfilled envelope.

In some embodiments the dispensing opening may include a top flap on an upper portion of the dispensing opening having a convex shaped flap. The dispensing opening may include a double top flap on an upper portion of the dispensing opening, the double top flap having two convex shaped flaps. The dispensing opening may include a double bottom flap on a lower portion of the dispensing opening, the double bottom flap having two convex shaped flaps.

In some embodiments the box may include a back panel with a matrix for placing medication information, and a privacy screen affixed along one edge of the privacy screen near a top of the box, wherein the privacy screen removably covers the matrix.

A medication management system for the visually impaired is also disclosed that may include a box having an exterior and multiple sections. The system may include medication packages in the multiple sections of the box. In some embodiments at least two medication packages include multiple medication doses. The exterior of the box may include tactile markers corresponding to the multiple sections.

The tactile markers may include embossed dots that differentiate the multiple sections, braille markings that differentiate the multiple sections, or embossed dividers between sections. In some embodiments the exterior of the box may include large print lettering on the top of the box that differentiates the multiple sections.

### BRIEF DESCRIPTION OF THE DRAWINGS

FIG. 1 is a top front perspective view of a medication management system according to some embodiments.

FIG. 2 is a front perspective view of a medication management system according to some embodiments.

FIG. 3 is a front elevational view of a medication management system according to some embodiments.

FIG. 4 is a side cut-away view of an embodiment of a medication management system along the line 4-4 from FIG. 1.

FIG. 5 is a top view of a strip of envelopes or packets according to some embodiments.

FIG. 6 is a top back perspective view of a medication management system according to some embodiments in an open state.

### DETAILED DESCRIPTION

Some embodiments of the disclosed solution may enable a blind or sight-impaired person, and their caregivers, not only to keep track of their medications in a single place, but also to keep track of what they took and when and to know whether they took or missed each dose. Some embodiments provide a solution to a patient's poor/lack of vision or dementia; may enable a caregiver to quickly, at a glance, identify whether the patient is on track with his/her medication or not; in some embodiments the solution does not rely on the patient to have a special reader or know braille, meaning it may work for the newly blind and sight-impaired patients who do not know braille.

Some solutions simplify the prospect of taking the prescribed doses of all medicines and might not require the patient or any caregiver to pro-actively prepare “Day-of-the-Week” pill boxes, which preparation may not always occur on time and which allows a large risk of human error on an ongoing basis.

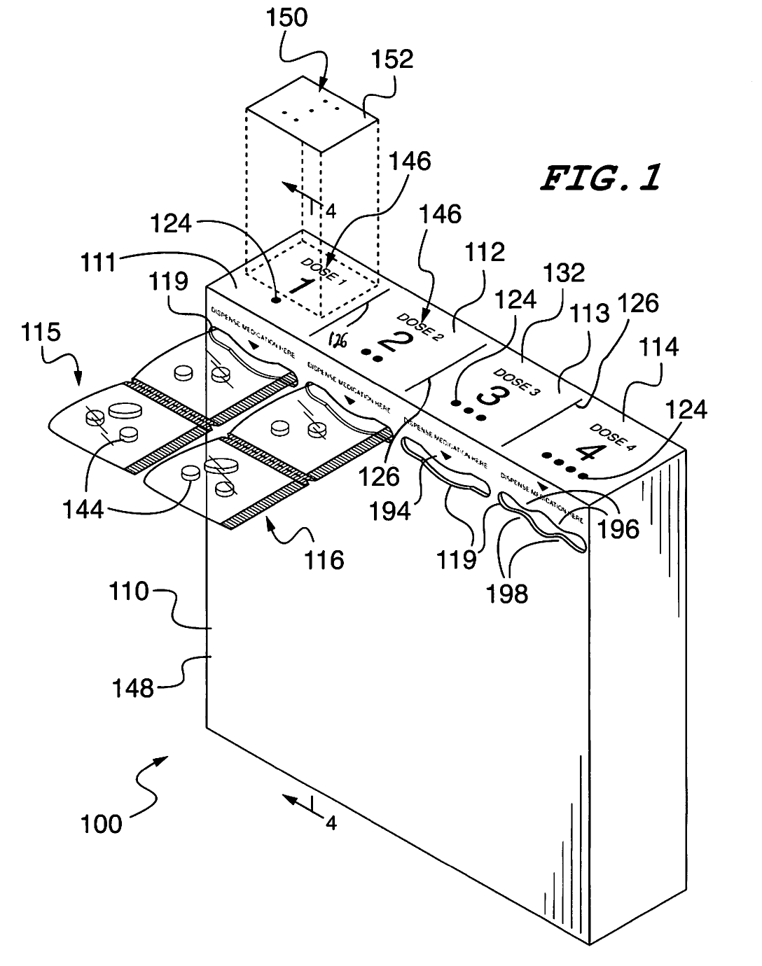

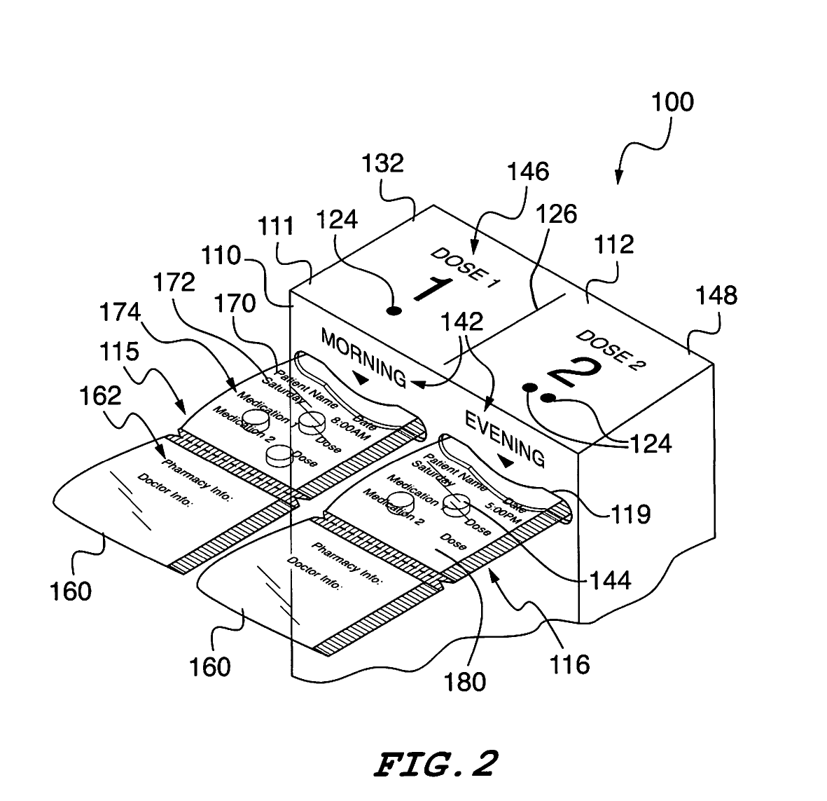

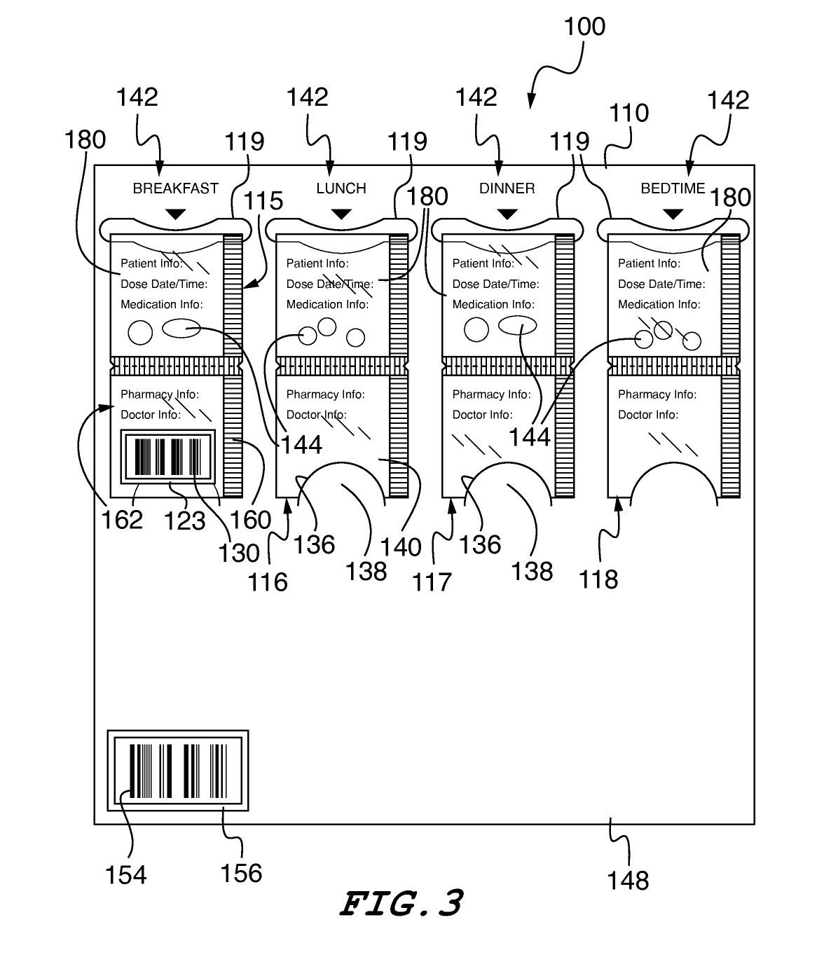

Referring to FIGS. 1 and 2 a medication management system 100 according to some embodiments may allow all pill forms of medications for a patient to be contained in a single box 110. Medication may be packaged in medication packaging strips, and each strip may be stored in a separate section of the box 110. For example, four medication packaging strips with doses of medication may be delivered each in its own section. The sections may be arranged horizontally from left to right along the top of the box so that a first section 111 may be labeled as “Dose 1 ” and a first medication packaging strip 115 may be stored in the first section 111, and may be dispensed in the upper left corner of the box 110. A second section 112 may be labeled as “Dose 2” and a second medication packaging strip 116 may be stored in the second section 112 and may be dispensed to the right of the first section 111. A third section 113 and a fourth section 114 may hold a third medication packaging strip 117 (shown in FIG. 3) and a fourth medication packaging strip 118 (shown in FIG. 3).

Some embodiments may include printed lettering 146 and tactile markings that may include raised markings 124 that may be textured identifiers along the top 132 of the box 110 that may enable both blind and sighted people to identify which section is which, so the blind patient knows where they stand in their medication for the day.

The box 110 and raised markings 124 on the box 110 may be designed to make it easy for sight-impaired people to identify the correct medication packaging strip with a medication dose envelope 180 to take by the dose time (Dose 1, 2, 3 or 4) even if they do not know braille or if they have some sight. This easy to see result may be accomplished by large, clear black and white printing of the dose numbers. Raised markings 124 may be large, red(or other color) raised dots on the top 132 of the box 110. The raised markings 124 may be embossed into the surface of the box. In some embodiments the raised markings 124 may be attached to the box, for example with adhesives or fasteners.

Tactile markings or features may also include embossed shapes, such as a box embossed around the lettering 124, a divider that may be an embossed divider 126 between the sections, or braille markings 150.

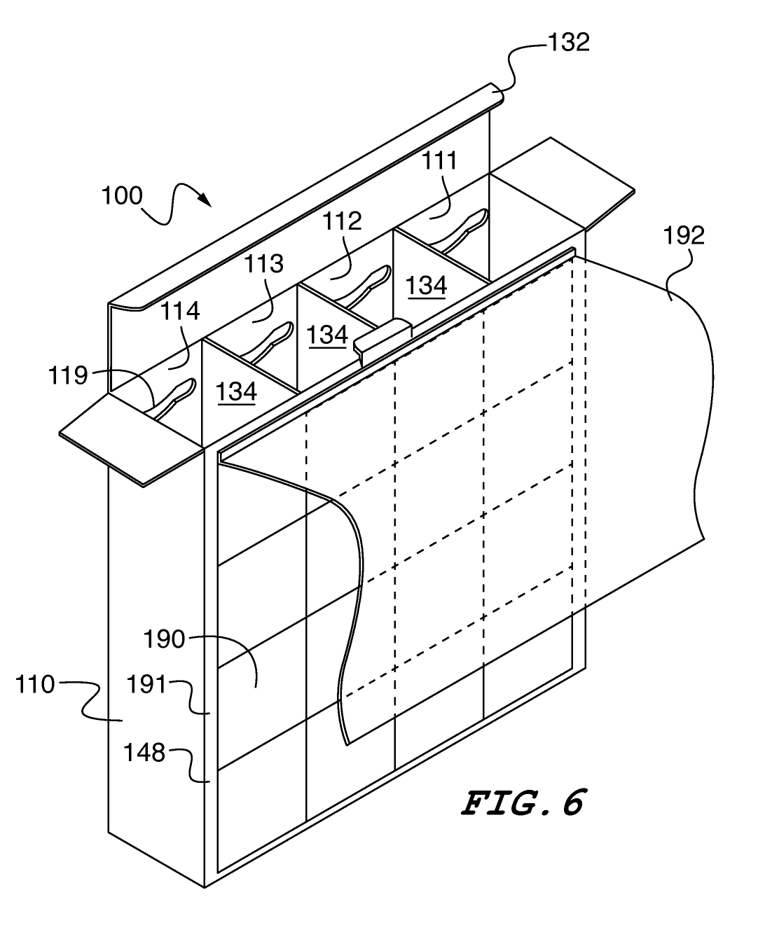

Dispensing of the doses may be done separately with all Dose 1 medication dose envelopes dispensed out of the first section 111, all and the Dose 2 medication dose envelopes dispensed out of the second section 112, etc. The top 132 of the box 110 may be visually segmented into segments roughly corresponding to the partitions 134 inside the box 110 (shown in FIG. 6), with each section marked with raised markings 124 corresponding to the Dose Number dispensed in the dispensing opening 119 vertically aligned with that partition 134 and that segment of the top 132. Each segment also may be marked with a large, easy-to-read number 146 corresponding to the Dose Number of the medication packaging strip in that partition 134 inside the box 110. Each segment also may be marked with the words Dose followed by the corresponding dose number.

In some embodiments a substantially transparent sticker 152 may be used with braille markings 150, which may be placed over part or all of printed lettering 146 so that printed lettering 146 may be seen through the substantially transparent sticker 152, while allowing a blind person to read the braille markings 150. In the illustration of FIG. 1 the braille markings mean “#1.” Other braille words may include “Dose” or the time of day for the dose. The substantially transparent sticker 152 may be placed over some or all of the printed lettering 146 and markings 142 on the exterior 148 of the box 110. The braille markings 150 may be placed over or adjacent to each of the printed lettering 146 on each section, or on some of the sections.

In some embodiments dispensing openings 119 may include a top flap 194 on the upper side of the dispensing opening 119 to prevent the medication packaging strip from falling back into the box 110. The top flap 194 may be shaped as a portion of a circle or any other generally convex shaped flap. In some embodiments the dispensing opening 119 may include a double top flap 196 that may include two half-moon shape flaps or other generally convex shaped flap on the upper side of the dispensing opening 119. In some embodiments the dispensing opening may include a double bottom flap 198, that may be used with or without the opening double top flap 196 to prevent the medication packaging strip from falling back into the interior of the box 110.

In some embodiments, as shown in FIG. 2, a box 110 may include only two sections, for example, if only two doses are needed each day. The exterior 148 of the box 110 may include markings 142 that may indicate the time of day when a dose should be taken. In the example shown in FIG. 2 the doses may be prescribed for the morning and the evening, and the markings 142 may indicate Morning and Evening.

Medication packaging strips 115, 116 may contain individual medication dose envelopes 180 that are releasably connected at their lateral edges (such as with a perforation) making a strip of envelopes that may be separated by tearing the perforation, for example, when it is time to take that dose. Each strip of envelopes may contain a particular dose for each day (Dose 1, for example) and may be arranged in date order with the earliest or soonest at the leading edge and the latest at the trailing edge of the strip. Individual medication dose envelopes 180 may be printed in large, easy-to-read black text on clear plastic identifying the patient name 170, the date and time 172 such as the day of the week, the date, the time for the dose to be taken, and the medication information 174 such as the type and dose of the pills in the packet or envelope and the description of each pill (color or shape).

Referring now to FIG. 3, a medication management system 100 may include in some embodiments tactile features including raised features 156 which may include a raised frame containing a QR or other such scannable code 154 that may enable the blind person to point their smartphone or other computer scanning device (including cell phones and other mobile devices with a camera) at the scannable code 154 (which they may locate by touch via the raised features 156) and hear pre-recorded audio instructions on how to use the dispensing box (in the conventional way such QR or other codes work, that is, by connecting the smartphone via wireless communications to an internet website which may stream the pre-recorded audio via the smartphone). The computer connected to the scanner may connect to a server with the information related to the medications. In some embodiments the raised features 156 may be a circle or other shapes. The raised features 156 may include bumps, braille lettering, or other raised features that can be recognized by touch and indicate to a user that a scannable code 154 is present. In some embodiments envelopes may have a scannable code 130 and raised features 123 to indicate the presence of a scannable code 130.

In some embodiments a leader section or unfilled envelope 160 may help a medication dose envelope 180 come out of the box 110 through the dispensing opening 119. The leader section or unfilled envelope 160 can separate the packets or medication dose envelopes 180 containing the medication 144, and can also provide more material to hold onto when tearing a medication packet or envelope from the strip, and can help prevent the strip from falling completely into the box 110 and can help the patient identify which doses for the day have and have not yet been taken. The leader section or unfilled envelope may have printed contact information for medical professionals 162 such as printed information that indicates the pharmacy contact information, and doctor contact information that is associated with the prescriptions, and could display other useful information.

In some embodiments the box 110 may include one or more cuts 136 that form flaps 138. The flaps 138 may be used to hold an end section 140 of the medication packaging strip. The flaps 138 may assist in displaying and retaining the medication packaging strips in a neat and orderly position, for example, in a position where the printed information for the next dose may be easily seen so that a patient or a healthcare worker can quickly determine if a dose was missed, or if all medication has been administered properly.

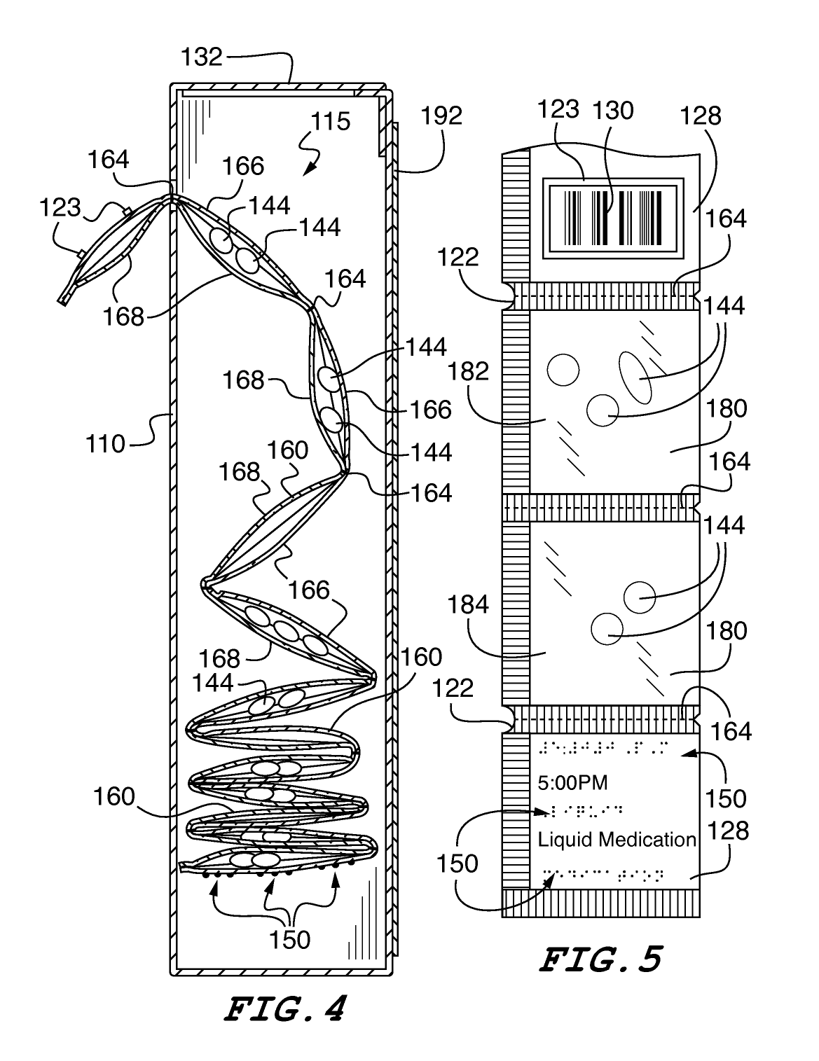

Referring to FIGS. 4, 5 and 6, in some embodiments the box 110 may be partitioned inside into two or more sections, such as into a first section 111, a second section 112, a third section 113, and a fourth section 114. FIG. 4 shows a cut-away side view along the line 4-4 from FIG. 1. A medication packaging strip such as first medication packaging strip 115 may be folded accordion-style into a stack with the trailing edge at the bottom of the stack and the leading edge at the top of the stack, and placed into a section, such as the first section 111. The first medication packaging strip 115 may be segregated from the other medication packaging strip or strips and may be dispensed through an opening 119 which may be near the top 132 of the box 110.

Referring to FIG. 6, in some embodiments a side of the box 110, for example the large back panel 191 of the box 110, may be marked with a matrix 190 in which the pharmacy may be instructed to apply prescription labels or labels containing prescription details for the medications inside the box 110. The box 110 may or may not incorporate a privacy screen 192 to hide prescription information from view. A privacy screen 192 may be a sheet of paper or other flexible non-transparent material that may be connected to the box 110 near the top 132 of the box, along one edge of the sheet. The privacy screen 192 can be lifted to view the information under privacy screen 192, which may include medication information and other information which should be kept private. The privacy screen 192 may be solid, opaque, or translucent and may make reading private medical information difficult or impossible without lifting the privacy screen 192.

The box 110 may be rectilinear and made of a semi-rigid or rigid material, which may be cardboard or plastic or a combination, or some other material. In some embodiments the box 110 opens and closes from the top 132 with a longitudinal opening along the top back of the box 110 and a hinged or folded top panel containing the printed lettering 146 with Dose Number markings such that when opened and viewed from the front, the printed lettering 146 and raised markings 124, may be displayed above and in alignment with the corresponding dispensing opening 119.

The doses may correspond to particular times of day, for example Dose 1 in the morning, Dose 2 at noon, Dose 3 in the afternoon and Dose 4 in the evening, or may correspond to meals or moments in the patient's daily routine, for example Dose 1 with breakfast, Dose 2 with lunch, Dose 3 with dinner and Dose 4 at bedtime, or the doses may correspond with other criteria given by the prescribing physician, according to the physicians' instructions for taking the medication.

The pharmacy may coordinate the grouping of medications into the proper medication doses according to the prescribing physicians' instructions for the various medications and the start and stop dates of each. The medication packaging strip may be prepared as with existing technology, such as the Parata PASS 208EO System, and may be printed with the desired information, such as patient name 170 and identifier, pharmacy name, Dose number, day of the week, date and time 172 or other criteria corresponding to that Dose number, identity and dosage 174 of medications 144 in the medication dose envelope 180, and indication of how many envelopes comprise that dose, in the case of doses that contain medications that cannot be included in the same envelope, for example if certain medications react with one another when packed together. The pharmacy then may place the doses into the proper medication packaging strip envelopes, may seal each envelope and may perforate the lateral edges so that each envelope may easily be removed by tearing the strip along the perforation. The pharmacy may produce a strip of envelopes with an empty envelope between each dose. If there are two or more envelopes that are to be taken as one dose, the pharmacy may place the two or more envelopes next to each other without any intervening empty envelopes 160.

In some embodiments an unfilled envelope 160 or leader section in some embodiments may be left between doses to help the patient or caregiver identify the doses that have and have not been taken. In some embodiments, the blind patient can feel how many consecutive envelopes contain medications. If she feels a first dose envelope 182 and then a between section 164 between the dose envelopes 180, and then a second dose envelope 184 with no unfilled envelope 160 between them, she may know that the two filled dose envelopes 182, 184 are a single dose and must be taken at the same time, whereas if she feels a filled envelope and then feels that the next envelope in the packaging strip may be empty she knows the one filled envelope contains all medications to be taken at that time or in that dose. An unfilled envelope 160 or leader between doses in a packaging strip also helps prevent the packaging strips from falling back into the box 110 through the dispensing opening 119.

In some embodiments a tactile marker may be placed on the medication packaging strip between medication dose envelopes 180. The tactile markers may be useful to a blind person to indicate information about the medication.

In some embodiments a tactile marker may include a notch 122 along the edge of the medication packaging strip may be used to indicate the next dose and to identify the perforation. In some embodiments where a first dose envelope 182 and a second dose envelope 184 are to be taken together, the between section 164 between the dose envelopes 180 may be made without a notch, while the between section 164 between dose envelopes 180 that is before the first dose envelope 182 may have a notch 122, and a section after the second dose envelope 184 may have a notch 122. In some embodiments the notches 122 are used to indicate separation between doses without empty envelopes between doses, and in some embodiments both notches 122 and empty envelopes 160 are used to indicate when doses are to be taken together. In some embodiments notches 122 may be placed between envelopes that are to be taken together, and an absence of notches may indicate separate doses to be taken at separate times.

In some embodiments tactile markers may include different types or shapes of notches, a bumpy or rough strip, a fuzzy, raised or embossed section or sticker. An tactile marker may include an unfilled envelope that may communicate to the patient, by the presence of the unfilled envelope, that the patient has found all of the envelopes for a current dose. The medication packaging strip may have a front 166 and a back 168. In some embodiments the tactile markers may be placed on the front 166 or the back 168 of the envelopes in the medication packaging strip.

In some embodiments unfilled envelopes may be used as reminder envelopes 128. Reminder envelopes 128 may be used to remind a patient to take medication that is not in pill form, or is not stored in the medication dose envelope. For example a reminder envelope 128 make direct a patient to use a nebulizer, take liquid medication, apply topical creams, or take medications that are prescribed but not delivered through the pharmacy. In some embodiments the reminder envelope 128 may have a reminder printed on the envelope. In some embodiments a raised feature 123 indicates presence of reminder information, which may be in text form, or as a scannable code 130, or in braille form 150.

The reminder envelopes 128 may be printed, overlayed with braille, incorporate a differentiating tactile marker (such as a different notch, a bumpy or rough strip, a fuzzy, raised or embossed section or sticker) or incorporate QR or other scannable codes 130 to enable the sight-impaired person to be reminded. In some embodiments the scannable computer code 154 on the box 110 may explain how to use the reminder envelopes and what they mean for that particular patient.

In some embodiments the envelopes may be printed and filled and then organized and attached at their lateral edges through other releasable attachment means, such as tape. In some embodiments, the strips may be printed, filled and sealed without perforation and may incorporate tear strips or other means to separate the envelopes at their lateral edges. Alternatively, tear strips or perforated slits or other opening means may be used to allow the patient access to the medications in the envelope with or without separating the envelope from the medication packaging strip.

A method of dispensing medication with a medication management system 100 according to some embodiments may include some or all of the following steps, which may be performed in the order listed, or in a different order: STEP 1; Patient medications 144 may be sorted into doses and dose groups according to prescribing physicians' instructions, with each dose containing medications to be taken together on specified dates and times and each dose group including doses to be taken at a specified time, for example morning doses in one dose group, noon or lunch doses in a second dose group, afternoon or dinner doses in a third dose group, and evening doses in a fourth dose group.

STEP 2; Medication packaging strips may be prepared for each dose group and printed with desired information.

STEP 3; doses may be placed into medication packaging strips with medication dose envelopes 180, corresponding to which specified time the dose is to be administered. The envelopes may be sealed. An unfilled envelope 160 may be placed between medication dose envelopes 180 or set of dose envelopes (to prevent strips from falling back into the box or to help a patient identify whether a single dose comprises multiple envelopes).

STEP 4; The medication packaging strips may be folded back and forth onto themselves into a stack with the trailing edge at the bottom of the stack and the leading edge at the top of the stack, and each stack may be placed into the corresponding section of the box 110. The first medication packaging strip 115, may be placed into the first section 111 of the box 110, labelled “DOSE 1” or other indication such as “Morning”. A second medication packaging strip 116, may be placed into the second section 112 of the box 110 to the right of the first section 111, labelled “DOSE 2” or other indication. This may be repeated for the third section 113 and fourth section 114, and for further sections as needed.

STEP 5; Each unfilled leader envelope 160 at the beginning of each medication packaging strip may be pulled and threaded through the dispensing opening 119 at the top of that section, so that the medication packaging strip may be easily found by the end-user.

STEP 6; The top 132 of the box 110 may be closed and secured.

STEP 7; Information labels pertaining to the medication enclosed may be affixed to the back panel 191 of the box in a matrix 190 printed so that columns correspond to the sections of the box.

A method of using a medication management system 100 according to some embodiments may include some or all of the following steps: STEP 1: By touch, user locates a raised square outline 156 located on the exterior 148 of the box 110, which contains the scannable QR code 154 or other scannable information.

STEP 2; User scans the QR code with a smart phone or other device, and may be connected to a website providing an audio recording containing instructions and other applicable information regarding use and care of the dispensing box. The audio recording information also may include information about the user's medications, instructions for taking the user's medications, side effects and cautionary disclosures or other information relevant to the user's medication and health.

STEP 3; By touch, user locates the raised markings 124 indicating the applicable dose and section. Or, by sight, user locates the raised markings 124, or the large corresponding Dose Number (1, 2, 3, or 4) 146 on the top 132 of the box 110, which identifies the applicable dose and section

STEP 4; By touch or sight, user locates the corresponding dispensing opening 119, located below the raised markings 124.

STEP 5; By touch or sight, user locates the unfilled leader envelope 160 and the following dose envelope 180 or set of dosing envelopes.

STEP 6; User removes the unfilled leader envelope 160 and the following dosing envelope 180 or set of dosing envelopes by tearing the envelopes from the medication packaging strip via a perforation, leaving the next doses' unfilled leader envelope attached to the medication packaging strip and hanging outside of the box 110.

STEP 7; User removes the dose from the envelope and ingests the medications 144 as directed.

STEP 8; User repeats steps 3 through 6 for each dosing time period (Dose 1, Dose 2, Dose 3, and Dose 4).

STEP 9; When all medication is dispensed, or earlier if directed by a doctor, user disposes of box 110 or returns it to the pharmacy to be refilled.

As used throughout this application, the term “markings” may include visual, tactile or coded markings or a combination of visual, tactile and coded markings. Tactile markings may include raised or embossed markings that are raised or lowered from a surface, glossy coating on a surface, fuzzy or patterned or otherwise distinct to the touch coating on a surface, a surface with holes punched or cut into the surface or other manner of making a surface features that may be perceived by touch.

As used throughout this application, the term “printed” may include printing of visually perceptible, tactilely perceptible or coded information.

As used throughout this application, the term “coded” or “coded information” means machine-readable code that can be scanned or read by a device and translated into audibly or visually perceptible information.

Use of the term “or” in this application is intended to be inclusive and not exclusive, so that “or” includes “and.” When “or” is used between two items, this indicates that one or both of the items may be included, and does not mean that only one of the two items can be included to the exclusion of the other item.

While the principles of the invention have been made clear in illustrative embodiments, there will be immediately obvious to those skilled in the art many modifications of structure, arrangement, proportions, and methods, the elements, materials, and components used in the practice of the invention, and otherwise, which are particularly adapted to specific environments and operative requirements without departing from those principles. The appended claims are intended to cover and embrace any and all such modifications, within the limits only of the true spirit and scope of the invention.

What is claimed is:

1. A medication management system comprising:
A box with multiple sections;
Medication packaging strips, wherein at least two medication packaging strips include medication dose envelopes serially connected together;
Wherein at least two of the multiple sections include a dispensing opening allowing the medication packaging strips to be dispensed serially through the dispensing openings.

2. The medication management system according to claim 1, further comprising a tactile marker between the medication dose envelopes.

3. The medication management system according to claim 2 wherein the tactile marker includes a notch in the medication packaging strips.

4. The medication management system according to claim 2 wherein the tactile marker includes a raised feature in the medication packaging strips.

5. The medication management system according to claim 2 wherein the tactile marker is on an empty medication dose envelope positioned between and connecting two filled medication dose envelopes.

6. The medication management system according to claim 1 wherein the medication dose envelopes include a reminder envelope for non-pill medications.

7. The medication management system according to claim 6 wherein the reminder envelope includes a scannable code.

8. The medication management system of claim 1 wherein the box includes a top and a bottom, and wherein the dispensing opening is positioned near the top.

9. The medication management system of claim 8 wherein the box includes a cut to create a flap below the dispensing opening, where the flap is configured to hold a portion of the medication packaging strips.

10. The medication management system according to claim 1 wherein at least two sections include markings that correspond with a time of day when medications should be taken, and wherein the medication packaging strips have medication dosages in the medication dose envelopes marked as designated for the time of day corresponding with one of the two sections.

11. The medication management system according to claim 1 wherein the box includes printed lettering on an exterior of the box corresponding to the multiple sections, and braille markings over the printed lettering.

12. The medication management system according to claim 11 wherein the braille markings are formed on a substantially transparent sticker, and wherein the substantially transparent sticker is placed over the printed lettering.

13. The medication management system according to claim 1 wherein the box has an exterior that includes a scannable code, and wherein the exterior of the box includes a tactile feature that can be recognized by touch adjacent to the scannable code.

14. The medication management system according to claim 13 wherein the tactile feature includes a raised box-shape which surrounds the scannable code.

15. The medication management system according to claim 1 wherein the medication packaging strips include a section between the medication dose envelopes that includes printed contact information for medical professionals related to a patient for whom medications are dispensed.

16. The medication management system according to claim 1 wherein the medication packaging strips include a section between the medication dose envelopes that includes an unfilled envelope.

17. The medication management system according to claim 1, wherein the dispensing opening includes a top flap on an upper portion of the dispensing opening, the top flap including a convex shaped flap.

18. The medication management system according to claim 1, wherein the dispensing opening includes a double top flap on an upper portion of the dispensing opening, the double top flap having two convex shaped flaps.

19. The medication management system according to claim 1, wherein the dispensing opening includes a double bottom flap on a lower portion of the dispensing opening, the double bottom flap having two convex shaped flaps.

20. The medication management system according to claim 1, wherein the box includes a back panel with a matrix for placing medication information, and a privacy screen affixed along one edge of the privacy screen near a top of the box, wherein the privacy screen removably covers the matrix.

21. A medication management system for the visually impaired comprising:
A box with an exterior, the box having multiple sections;
Medication packages in the multiple sections of the box, wherein at least two medication packages include multiple medication doses;
Wherein the exterior of the box includes tactile markers corresponding to the multiple sections.

22. The medication management system according to claim 21 wherein the tactile markers include embossed dots that differentiate the multiple sections.

23. The medication management system according to claim 21 wherein the tactile markers include braille markings that differentiate the multiple sections.

24. The medication management system according to claim 21 wherein the tactile markers include embossed dividers between sections.

25. The medication management system according to claim 21 further comprising large print lettering on the top of the box that differentiates the multiple sections.
